(19) United States
(12) Patent Application Publication
(10) Pub. No.: US 2013/0028324 A1
(43) Pub. Date: Jan. 31, 2013

(54) METHOD AND DEVICE FOR DECODING A SCALABLE VIDEO SIGNAL UTILIZING AN INTER-LAYER PREDICTION

(71) Applicants: YUNG CHANG, HSINCHU CITY (TW); PO-TSANG HUANG, HSINCHU CITY (TW); WEI HWANG, HSINCHU CITY (TW); YU-CHEN CHEN, HSINCHU CITY (TW); GWO-LONG LI, HSINCHU CITY (TW); TIAN-SHEUAN CHANG, HSINCHU CITY (TW)

(72) Inventors: YUNG CHANG, HSINCHU CITY (TW); PO-TSANG HUANG, HSINCHU CITY (TW); WEI HWANG, HSINCHU CITY (TW); YU-CHEN CHEN, HSINCHU CITY (TW); GWO-LONG LI, HSINCHU CITY (TW); TIAN-SHEUAN CHANG, HSINCHU CITY (TW)

(73) Assignee: NATIONAL CHIAO TUNG UNIVERSITY, HSINCHU CITY (TW)

(21) Appl. No.: 13/193,736

(22) Filed: Jul. 29, 2011

(51) Int. Cl. H04N 7/32; H04N 7/28

(52) U.S. Cl. 375/240.16; 375/240.12; 375/E07.125; 375/E07.092

(57) ABSTRACT

A method and device for decoding a scalable video signal utilizing an inter-layer prediction are provided herein. An inter-layer pre-fetch scheme (IPS) is presented to improve the performance for scalable video coding (SVC) decoder. With proposed invention, the required information for inter-layer prediction in SVC technique will be pre-fetched ahead when reconstructing the enhancement layer so that the cache miss rate can be reduced significantly. Accordingly, the execution time and memory energy consumptions can be improved.

### BACKGROUND OF THE INVENTION

1. Field of the Invention

The present invention is related to a method and device for decoding a video, and more particularly to a method and device for decoding a scalable video signal utilizing an inter-layer prediction scheme.

2. Description of the Prior Art

A state-of-the-art scalable hierarchical coding standard, called scalable video coding (SVC), can allow the information to be encoded hierarchically in order and decoded at different resolution and/or quality levels. The spatially scalable hierarchical encoding/decoding method can encode/decode a first part of data called base layer relating to low resolution images, and encode/decode at least another data part called enhancement layer relating to high resolution images from this base layer. The coding information regarding the enhancement layer can be possibly derived from coding information associated with the base layer by an inter-layer prediction method. In the inter-layer prediction method, each macroblock of a high resolution image may temporally be predicted according to three inter-layer prediction modes. However, DRAM access penalty may be an issue in the typical inter-layer prediction method.

### SUMMARY OF THE INVENTION

The present invention is directed to a method and device for decoding a scalable video signal utilizing an inter-layer prediction wherein the required information for inter-layer prediction in SVC decoding will be pre-fetched ahead when reconstructing the enhancement layer, so that the execution time and cache miss rate can be improved.

A method for decoding a scalable video signal utilizing an inter-layer prediction, wherein the scalable video signal includes a base layer and at least an enhancement layer associated with the base layer, each of the base layer and enhancement layer including at least two consecutive macroblocks, the method includes: decoding the base layer; reconstructing the current macroblock of the enhancement layer by fetching a first reference data associated with the current macroblock from a cache memory; pre-fetching a second reference data related to the next marcoblock of the base layer; and storing the second reference data in the cache memory.

A device for decoding a scalable video signal utilizing an inter-layer prediction includes: a cache memory; and a decoding unit coupled to the cache memory, executing a decoding method for the scalable video signal, wherein the scalable video signal includes a base layer and at least an enhancement layer associated with the base layer, each of the base layer and the enhancement layer including at least two consecutive macroblocks, includes the steps of: decoding the base layer; reconstructing the current macroblock of the enhancement layer by fetching a first reference data associated with the current macroblock from the cache memory; pre-fetching a second reference data related to the next marcoblock from the base layer; and storing the second reference data in the cache memory.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

FIG. 1 is a flow chart schematically illustrating the steps of the method for decoding a scalable video signal utilizing a inter-layer prediction according to one embodiment of the present invention;

FIG. 2 is schematic diagrams illustrating the method for decoding a scalable video signal utilizing a inter-layer prediction according to one embodiment of the present invention;

FIG. 3 is schematic diagrams illustrating the device for decoding a scalable video signal utilizing a inter-layer prediction according to one embodiment of the present invention;

FIG. 4 is a comparison chart schematically illustrating the cache miss rate according to one embodiment of the present invention and the prior art;

FIG. 5 is a comparison chart schematically illustrating total memory energy consumption according to one embodiment of the present invention and the prior art;

FIG. 6 is a simulation result of the L2 cache access count with different L2 cache size according to one embodiment of the present invention and the prior art; and

FIG. 7 is a simulation result of the DRAM access count with different L2 cache size according to one embodiment of the present invention and the prior art.

### DESCRIPTION OF THE PREFERRED EMBODIMENT

The detailed explanation of the present invention is described as follows. The described preferred embodiments are presented for purposes of illustrations and description, and are not intended to limit the scope of the present invention.

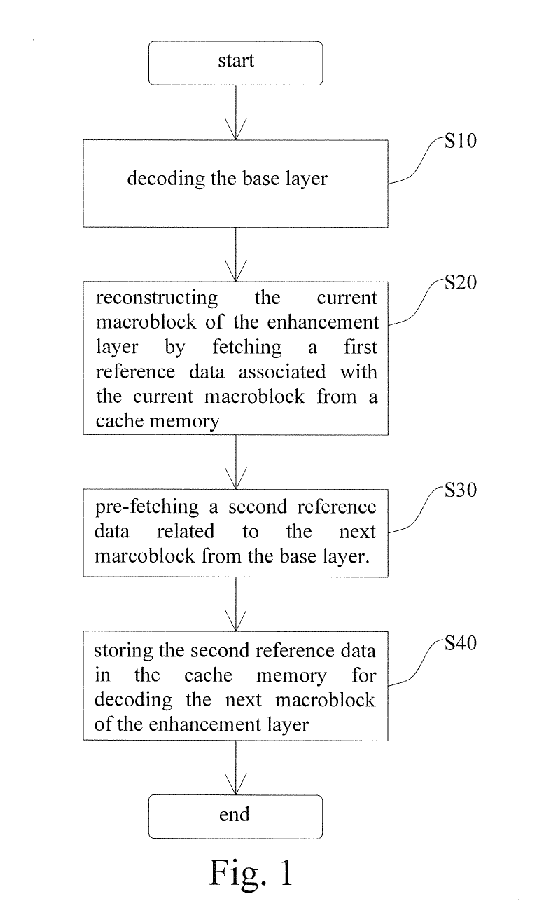

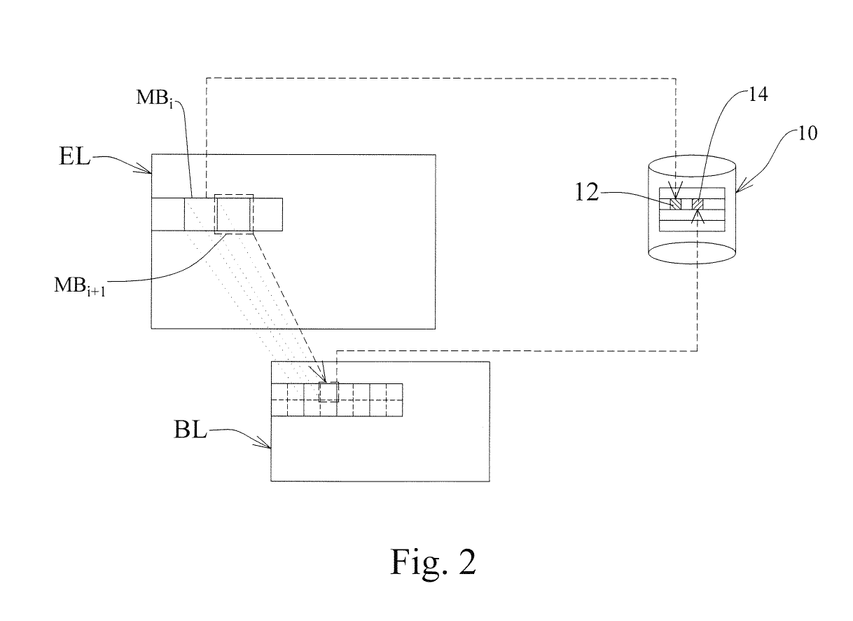

According to an embodiment in reference to FIG. 1 and FIG. 2, the method for decoding a scalable video signal utilizing an inter-layer prediction is provided herein, wherein the scalable video signal includes a base layer BL and at least an enhancement layer EL associated with the base layer BL. Each base layer BL and enhancement layer EL includes at least two consecutive macroblocks MBᵢ, MBᵢ₊₁ where i denotes the ith marcoblock, i=1 to N−1, and N is a positive integer which denotes the number of marcoblocks. The present method includes the following steps. The base layer BL is decoded first (S10), and the decoded data, called reference data hereafter, may be stored in a main memory. Then, when the current macroblock MBᵢ of the enhancement layer EL is reconstructed, a first reference data 12 associated with the current macroblock MBᵢ will be fetched from a cache memory 10 or the main memory for decoding reference (S20). Then, a second reference data related to the next marcoblock MBᵢ₊₁ is pre-fetched from the base layer BL (S30). Finally, the second reference data is stored in the cache memory 10 for decoding the following macroblock of the enhancement layer (S40). It is noted that the decoding steps S10 to S40 can be repeated while the macroblock MBᵢ (i=1 to N−1) of the enhancement layer EL is reconstructed.

Continued from the above description, in the embodiment, the enhancement layer EL is decoded by an inter-layer motion prediction and/or an inter-layer residual prediction. Besides, the first/second reference data include a residual data and/or a motion vector data. In one embodiment, when the enhancement layer EL is decoded by an inter-layer motion prediction, all the motion vector data within a predetermined MB block size are pre-fetched from the base layer BL, wherein the predetermined MB block size can be but not limited to 8×8. In another embodiment, when the enhancement layer is decoded by an inter-layer residual prediction, the residual data are calculated by applying a bilinear interpolation algorithm on data within a predetermined MB block size, 8×8 for example, from the base layer before being pre-fetched from the base layer BL.

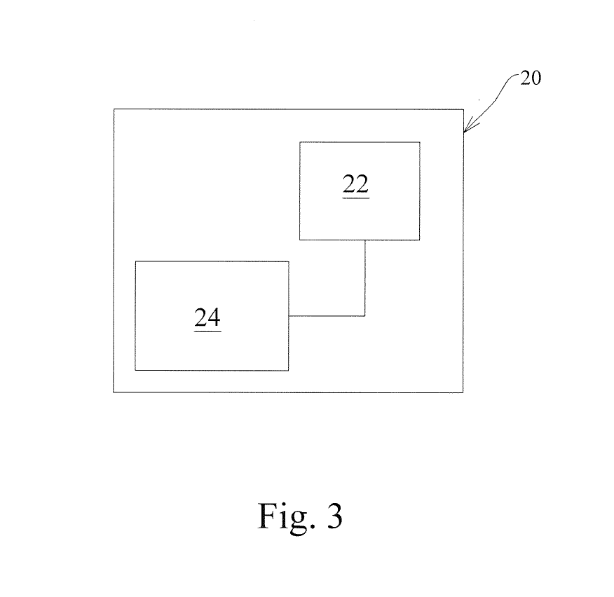

According to an embodiment in reference to FIG. 3, a device applies the decoding method for a scalable video signal utilizing an inter-layer prediction. The device 20 includes a cache memory 22 and a decoding unit 24 coupled to the cache memory 22, to execute a decoding method for the scalable video signal by utilizing an inter-layer prediction, wherein the device may be implemented as a single (integrated circuit) chip, multiple chips or other electronic device. The detail description of the steps has been provided above and would be skipped here.

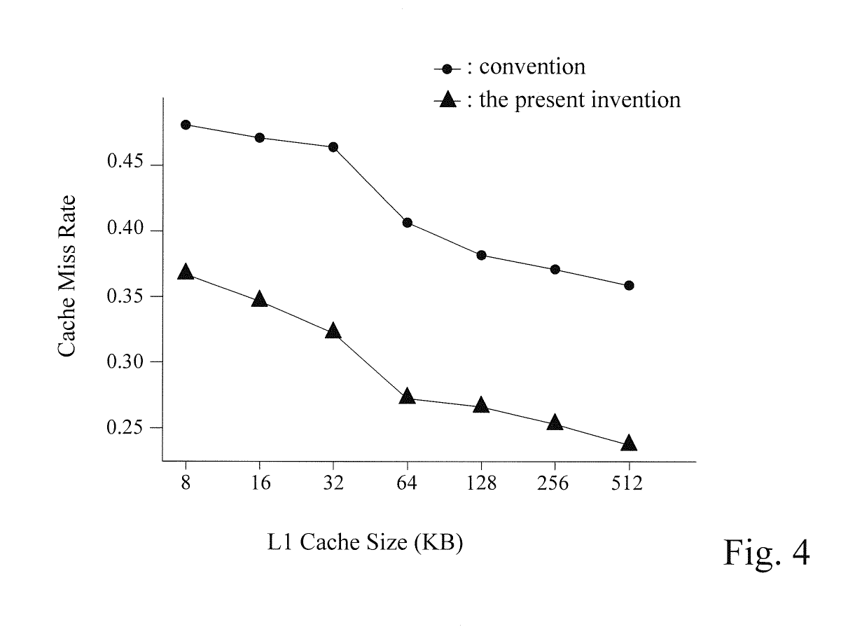

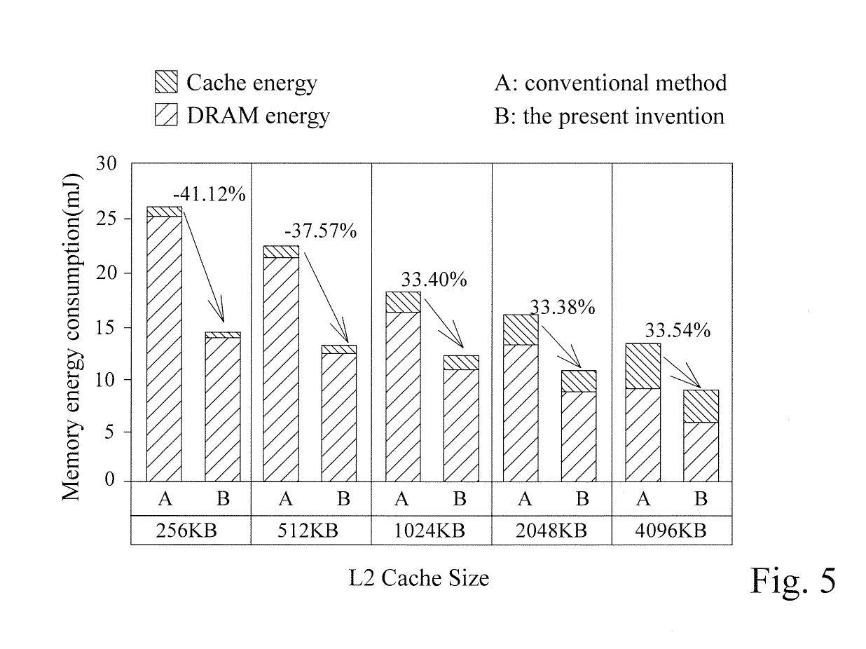

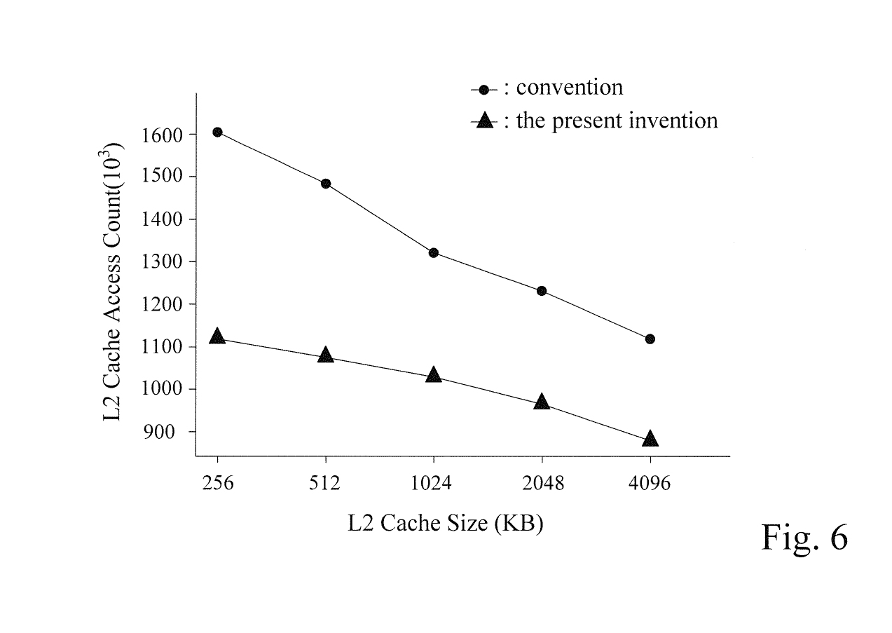

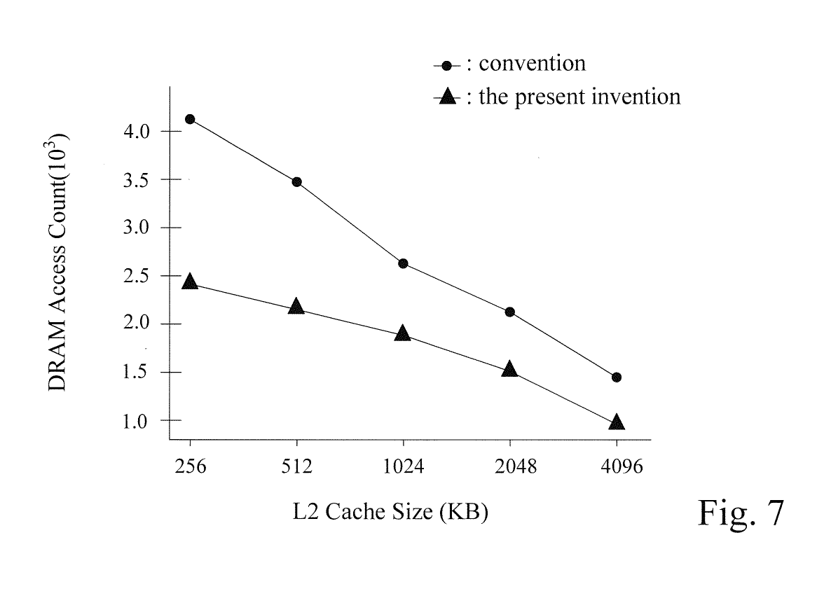

With the proposed method and device as mentioned above, the miss rate of cache memory can be improved for the scalable video coding (SVC) application. FIG. 4 shows the simulation result of the cache miss rate with different L1 cache size. By using the pre-fetch scheme, the cache miss rate can have 30.1% reduction on average. It is noted that a 4-way association cache configuration and a Least Recently Used (LRU) replacement policy are applied in the simulation. Besides, the comparison chart for the total memory energy consumption including on-chip cache and off-chip DRAM with different L2 cache size is shown in FIG. 5, wherein the 8-way association cache configuration and the LRU replacement policy are applied in the simulation. The pre-fetch scheme can be utilized to reduce the execution time and energy consumption significantly because it directly reduces the number of DRAM access with lowered cache miss probability. In addition, the pre-fetch scheme can be utilized to reduce 32.09% energy consumption on average. Further, the simulation result of the L2 cache access count and DRAM access count with different L2 cache size are respectively shown in FIG. 6 and FIG. 7, wherein L1 cache provided with a 4-way association cache configuration and the LRU replacement policy and L2 cache provided with 8-way association cache configuration and LRU replacement policy are applied in the simulation. Comparison to the conventional method/device, the L2 cache access count and the DRAM access count can respectively have 24.6% and 34% reduction on average by using the pre-fetch scheme.

To summarize the foregoing descriptions, the method and device for a scalable video signal utilizing an inter-layer prediction arranges the required information for inter-layer prediction in SVC decoding to be pre-fetched ahead when reconstructing the enhancement layer, so that the execution time and cache miss rate can be reduced. Furthermore, the unnecessary misses in cache memory and the number of DRAM access caused by cache data replacement can also be reduced.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A method for decoding a scalable video signal utilizing an inter-layer prediction, wherein said scalable video signal comprises a base layer and at least an enhancement layer associated with said base layer, each of said base layer and said enhancement layer comprises at least two consecutive macroblocks, comprising the steps of:
decoding said base layer;
reconstructing said current macroblock of said enhancement layer by fetching a first reference data associated with said current macroblock from a cache memory;
pre-fetching a second reference data related to said next marcoblock from said base layer; and
storing said second reference data in said cache memory.

2. The method according to claim 1, wherein said enhancement layer is decoded by an inter-layer motion prediction and/or an inter-layer residual prediction.

3. The method according to claim 1, wherein said first reference data and said second reference data comprise a residual data and/or a motion vector data.

4. The method according to claim 3, wherein all said motion vector data within a predetermined MB block size are pre-fetched from said base layer for reference when said enhancement layer is decoded by an inter-layer motion prediction.

5. The method according to claim 4, wherein said predetermined MB block size comprises 8×8.

6. The method according to claim 3, wherein when said enhancement layer is decoded by an inter-layer residual prediction, said residual data are calculated by applying a bilinear interpolation algorithm on data within a predetermined MB block size from said base layer before being pre-fetched.

7. The method according to claim 6, wherein said predetermined MB block size comprises 8×8.

8. A device for decoding a scalable video signal utilizing an inter-layer prediction, said device comprising:
a cache memory; and
a decoding unit coupled to said cache memory, executing a decoding method for said scalable video signal, wherein said scalable video signal comprises a base layer and at least an enhancement layer associated with said base layer, each of said base layer and said enhancement layer comprising at least two consecutive macroblocks, comprising the steps of:
decoding said base layer;
reconstructing said current macroblock of said enhancement layer by fetching a first reference data associated with said current macroblock from said cache memory;
pre-fetching a second reference data related to said next marcoblock from said base layer; and
storing said second reference data in said cache memory.

9. The device according to claim 8, wherein said enhancement layer is decoded by an inter-layer motion prediction and/or an inter-layer residual prediction.

10. The device according to claim 8, wherein said first reference data and said second reference data comprise a residual data and/or a motion vector data.

11. The device according to claim 10, wherein all said motion vector data within a predetermined MB block size are pre-fetched from said base layer for reference when said enhancement layer is decoded by an inter-layer motion prediction.

12. The device according to claim 11, wherein said predetermined MB block size comprises 8×8.

13. The device according to claim 10, wherein when said enhancement layer is decoded by an inter-layer residual prediction, said residual data are calculated by applying a bilinear interpolation algorithm on data within a predetermined MB block size from said base layer before being pre-fetched.

14. The device according to claim 13, wherein said predetermined MB block size comprises 8×8.

15. The device according to claim 8, wherein said device is implemented as a single chip.
